(19) United States
(12) Patent Application Publication
(10) Pub. No.: US 2026/0219000 A1
(43) Pub. Date: Jul. 30, 2026

(54) SEPARATION OF CLEANING BODIES FROM A STREAM OF FLUID

(71) Applicant: TAPROGGE GMBH, Wetter (DE)

(72) Inventors: Dietmar ALTEGOER, Witten (DE); Simon HÖCKENKAMP, Lüdinghausen (DE); Guido KELLER, Hagen (DE)

(73) Assignee: TAPROGGE GMBH, Wetter (DE)

(21) Appl. No.: 19/142,120

(22) PCT Filed: Dec. 5, 2023
(86) PCT No.: PCT/EP2023/084362

§ 371 Date: Jun. 20, 2025

(30) Foreign Application Priority Data
Dec. 20, 2022 (EP) 22215152.4

(51) Int. Cl. F28G 1/12; B08B 9/053

(52) U.S. Cl. CPC F28G 1/12; B08B 9/053

(57) ABSTRACT

A device and method for separating cleaning elements from a fluid stream. A pipe wall serves to direct the fluid stream from an upstream side to a downstream side. A screen is arranged within the pipe wall. The screen has a frustoconical screen surface for directing cleaning elements to a cleaning element extractor arranged in the direction of the downstream side. A lift-off device includes at least one vortex body arranged substantially parallel to the screen surface. The vortex body is arranged to rotate or swivel about a rotary shaft such that it sweeps over the screen surface. An intermediate space is formed between the vortex body and the screen surface. The vortex body has a cover at least at the end directed towards the upstream side. The intermediate space is partially closed by the cover such that it covers 5%-80% of a cross-sectional area of the intermediate space.

### FIELD OF THE INVENTION

The invention relates to a device and a method for separating cleaning elements from a fluid stream.

### BACKGROUND OF THE INVENTION

For cleaning systems through which fluid flows, in particular pipes such as in heat exchangers, it is known to place cleaning elements in the fluid stream so that they move through the system with the fluid stream and thereby achieve a cleaning effect. For example, the cleaning elements can be spherical and have a core made of flexible material such as sponge rubber. If the dimensions (e.g. ball diameter) and properties (e.g. degree of hardness) of the cleaning elements are suitably matched to the respective system, very efficient cleaning of pipes can be achieved.

After passing through the system parts to be cleaned, the cleaning elements are preferably extracted from the fluid stream, e.g. water stream.

DE 3938566 A1 discloses a method and a device for separating cleaning elements from a cooling water flow downstream of a tubular heat exchanger. The cleaning elements are collected on a screen, lifted from the screen by a lifting device and fed to an outlet opening. The lifting device uses flow guide elements to generate a cylindrical vortex that acts right into the screen openings, thereby lifting cleaning elements and soiling from the screen surface and causing them to rotate around the vortex core. By extracting a small amount of water from the vortex chamber, an axial component is imposed on the vortex roller, which can be supported by an inclined arrangement with respect to the water flow. This transports cleaning elements and dirt to the suction opening. By moving the vortex roller relative to the screen surface, all areas of the screen are covered one after the other.

RU 2 721 468 C1 describes a ball catching device as part of a ball cleaning system for installation in a drain line for circulating water downstream of a heat exchanger for trapping contaminated balls in contaminated water. Three embodiments are described, the first of which is equipped with a stationary ball trap screen in the form of a straight circular truncated cone with automatic rinsing by return water using a rotating vortex cleaner with forced backwash on the inside of the cone. The second embodiment is equipped with a stationary ball trap screen in the form of a straight circular truncated cone with automatic rinsing by reverse water flow by means of a vortex inductor on the inside of the cone and with forced rinsing under directed excessive water pressure from the outside of the cone, with the option of two variants of the forced rinsing system: one common drive or two independent drives. The third embodiment is equipped with a movable ball catching screen in the form of parts of a straight circular truncated cone with a mechanism for opening parts of the screen, with automatic cleaning of the inside of the cone with water backflow by means of a vortex inductor attached to it and with optional use of forced rinsing under excess water pressure from the outside of the cone, also this with two possible versions of the drive system of the optional forced rinsing.

U.S. Pat. No. 5,728,297 A discloses a device for the mechanical cleaning of liquids, in particular cooling water, conveyed from a heat exchanger and flowing in a pipe. The device comprises a rotationally symmetrical, conical screen of approximately the size of the pipe diameter and a co-axial screen suction device which is arranged on the upstream side of the screen and is mounted to rotate continuously or intermittently for the duration of a cleaning interval and gradually sucks off the entire surface of the screen during the cleaning interval. On the upstream side, the screen is divided into areas, whereby the suction nozzle of the suction device can cover the respective areas. In each area of the actual screen surface and the suction device there is a cavity for the temporary absorption of dirt, whereby the screen is divided into individual sectors forming the areas on its upstream side by essentially radial barriers. The suction nozzle of the suction device has a shape such that, at the moment when the suction nozzle just covers a sector and leaves adjacent sectors essentially free, the gap between the free barrier edges and the edges of the suction nozzle of the suction device is sealed by sealing lips of at least the height of the gap. Preferably, the apex of the cone has no barriers and the ends of the barriers arranged in the remaining area have no closures, resulting in funnel-shaped chutes so that hard dirt, such as stones, shells, slide along the screen surface into the barrier-free apex of the cone where they are sucked out of the opening provided in the coupling pipe.

DE 8526836 U1 relates to a device for collecting cleaning elements from a cooling water flow downstream of a heat exchanger provided with pipes. The cleaning elements flow through the pipes of the heat exchanger in a circuit to clean them. The device comprises a pipe section with at least one screen arranged therein and at least one drain opening in the wall of the pipe section, which is connected to the suction nozzle of a pump. The drain opening is connected to a suction device with a water inlet opening. The part of the suction device with the water inlet opening and the screen are arranged so that they can move relative to each other.

### SUMMARY OF THE INVENTION

It can be regarded as an object to provide a device and a method for separating cleaning elements from a fluid stream, with which a reliable extraction of the cleaning elements is achieved in a particularly simple design.

The object is solved by a device, a cleaning system therewith and a method according to the invention.

The device according to the invention for separating cleaning elements from a fluid stream is also referred to below for simplicity as a “screen device”, as it is designed to filter out and extract cleaning elements, which are usually spherical in shape, from the fluid stream (usually water stream).

The device according to the invention comprises a pipe wall which is designed to conduct the fluid stream from an upstream side to a downstream side. The device can thus be a section of a pipe, e.g. for discharging (cooling) water from a heat exchanger. The interior space formed by the pipe wall preferably has a circular cross-section, although other cross-sectional shapes are not excluded.

A screen and at least one outlet for the cleaning elements are arranged inside the pipe wall. The screen is used to retain the cleaning elements. The cleaning elements, preferably balls, e.g. made of sponge rubber, can be discharged through the cleaning element extractor, preferably together with a portion of the flowing fluid. The cleaning element extractor preferably comprises a pipe leading to the outside, which runs, for example, transverse to the direction of flow and penetrates the pipe wall. The direction of flow is understood to be the direction from the upstream side to the downstream side, preferably parallel to the wall or a longitudinal center axis of the pipe.

An inlet area of the cleaning element extractor can be arranged at various points of the cross-section of the pipe wall, including, for example, laterally close to the wall, but is preferably arranged at least essentially centrally in the pipe wall. Preferably, the inlet area comprises an opening oriented towards the upstream side, while it is closed towards the downstream side.

According to the invention, the screen has a frustoconical screen surface which is formed in such a way that it serves to guide the cleaning elements to the cleaning element extractor. The inlet area of the cleaning element extractor is preferably arranged at the tip of the truncated cone and preferably adjoins the screen surface. The truncated cone shape of the screen surface has a round cross-section, with the conical shape preferably being oriented in such a way that the dimensions taper towards the downstream side, i.e. towards the cleaning element extractor. While oblique arrangements are also conceivable in principle, the truncated cone is preferably aligned with its central axis parallel to the direction of flow and to the central axis of the pipe wall, particularly preferably at least substantially centered.

While flatter cone shapes are also conceivable in principle, the preferred cone shape has a relatively steep inclination of the cone surface, so that the screen surface in longitudinal section preferably forms an angle with the longitudinal center axis of the pipe wall or the truncated cone that is less than 60°, e.g. 15-60°, preferably 20-45°.

According to the invention, a movable lift-off device is provided with at least one vortex body, preferably arranged at least substantially parallel to the screen surface, which can serve locally to form vortex flows in the fluid stream. The vortex body is arranged to rotate or swivel about a rotary shaft in such a way that it sweeps over the screen surface during movement. Preferably, the vortex body has an elongated shape, i.e. it preferably has a length that is at least twice its width, preferably at least 5 times its width. The vortex body is preferably straight and can, for example, have a profile shape, i.e. a cross-sectional shape that is at least essentially constant over its length. The vortex body preferably has essentially the length of the screen surface (measured in longitudinal section). The arrangement of the vortex body relative to the screen surface can also include a slight inclination of, for example, no more than 10°, preferably no more than 5°, in deviation from an exactly parallel alignment. Preferably, the vortex body is arranged at a small distance from the screen surface, so that it preferably sweeps over the entire length but does not touch it. Further preferably, the distance is such that no balls can be squeezed between the vortex body and the screen surface.

According to the invention, the lift-off device is designed such that an intermediate space is formed between the vortex body and the screen surface. The intermediate space can be represented in particular in a cross-section through the vortex body and the screen surface located thereunder. The dimensions of the intermediate space are understood as being limited by lines perpendicular to the screen surface up to the outer edges of the vortex body.

As it moves across the screen surface, the vortex body causes vortices in the fluid stream, which are directed from the upstream side to the downstream side. On the one hand, these vortices cause dirt to be lifted off the screen surface and, on the other hand, transport cleaning elements that are temporarily present there.

According to the invention, the vortex body has a cover at least at one end, namely the end directed towards the upstream side (hereinafter also occasionally referred to as the “upper” end for simplification), by means of which the intermediate space is at least partially closed. Preferably, the vortex body has no cover at the opposite other end, referred to here as the “lower” end, so that the intermediate space is completely open at the lower end.

As has been shown, this also influences the flow conditions on the vortex body and thus the transport of the cleaning elements. The cover results in an increased flow component in the longitudinal direction of the vortex body and along the intermediate space in the direction of the cleaning element extractor. As a result, the cleaning elements are concentrated and collected at the outlet, which enables extraction with a comparatively small amount of fluid and represents an improvement by reducing the amount of fluid required to extract the cleaning elements.

The device according to the invention uses only a vortex body as an element movable relative to the screen surface, under which an intermediate space open along the sides is formed. The vortex body acts as an obstacle to be flowed around in the fluid stream, whereby the desired vortex flows are formed. Such a passive arrangement differs from an active suction device, in which a suction head is located in front of the screen surface and external suction causes a reversal of the flow direction through the screen surface below the suction head.

The lift-off device is preferably arranged so that the rotary shaft lies in the longitudinal axis of the truncated cone formed by the screen surface. The vortex body can be arranged with a holder on the rotary shaft in such a way that the rotary shaft, the holder and the vortex body can rotate together, whereby in addition to uniform rotation in one direction, other movement patterns are also understood, such as intermittent rotation, alternating swivelling in opposite directions, etc.

The device according to the invention and the process according to the invention carried out by its operation enable very good functionality with a simple design of the device, on the one hand with regard to the transport of cleaning elements and on the other hand also for cleaning the screen surface by lifting off dirt. Although other parts can be designed to be movable if required, it is only actually necessary for the vortex body (or possibly several vortex bodies) to be movable relative to the screen surface, while other parts of the device can be fixed.

The size and shape of the cover at the upper end of the vortex body can be selected differently depending on the design and the desired effect. According to the invention, the cover is designed such that it covers at least 5% of the cross-sectional area of the intermediate space, but not more than 80%. A cover of 10-40% of the cross-sectional area, particularly preferably 10-30%, is considered to be particularly suitable. With this design of the cover, favorable flow conditions have been shown for transporting the cleaning elements along the length of the vortex body.

Various shapes, in particular cross-sectional shapes, can be considered for the design of the vortex body. In particular, the vortex body can have a cross-sectional shape that has an interior space that is open in the direction of the screen surface but closed in the opposite direction, i.e. is concave. The vortex body can preferably have two parallel end edges on the side facing the screen surface, which are further preferably arranged at the same distance from the screen surface. The cross-sectional shape of the vortex body is also preferably symmetrical with respect to the perpendicular to the screen surface.

As a possible cross-sectional shape, the vortex body can, for example, be shaped as part of an arc of a circle (preferably with the concave side towards the screen surface), or alternatively, for example, angled, in a polygonal shape, in a U-shape (preferably with the open side towards the screen surface) or in a T-shape (preferably with the flat side towards the screen surface).

According to a particularly preferred embodiment, the vortex body can have a cross-sectional shape referred to here as a roof shape with two (roof) legs arranged at an angle. The angle between the legs can be, for example, 60-120°, preferably 70-100° to each other. The roof legs have, for example, a length of 30-120 mm, preferably 50-70 mm. The two legs are preferably the same length.

According to a preferred embodiment, the distance between the vortex body and the screen surface is 20-80 mm, particularly preferably 30-50 mm. The distance can preferably be measured as the shortest perpendicular from the screen surface to a part of the vortex body. This leaves a sufficiently large free area below the vortex body so that the vortex flows triggered by the vortex body can take effect. At the same time, the sufficient distance ensures that no cleaning balls are squeezed between the vortex body and the screen surface.

In principle, the screen can be constructed in various ways, including, for example, as a wire screen or perforated plate. Preferably, the screen is constructed with a plurality of parallel screen bars, between which screen gaps are formed as slots. The screen bars can have different cross-sectional shapes, e.g. round, square or triangular. A screen with screen bars of rectangular cross-section is particularly preferred. Particularly preferably, the height of the cross-sectional shape (i.e. the dimension transverse to the screen surface) is greater than the thickness (i.e. the dimension parallel to the screen surface) and is further preferably at least double, so that the height/thickness ratio is at least 2, particularly preferably in the range 5-20.

In a preferred embodiment, the screen bars are arranged parallel to each other and preferably at an angle in the direction of flow, i.e. the direction from the upstream side to the downstream side, and preferably also the longitudinal center axis of the pipe wall. The inclined course of the screen bars corresponds to the inclined course of the screen surface in the longitudinal section. As a result, the fluid flows at least partially along the screen bars, which minimizes flow disturbances and leads to the lowest possible pressure loss. Particularly with the preferred steep shape of the truncated cone, the screen bars (when considering a vector decomposition) extend predominantly in the direction of flow.

According to a preferred embodiment of the invention, the screen with the truncated cone-shaped screen surface may comprise one or more tension rods which are curved in a circular or pitch circle shape. Screen bars can then be connected to the tension rods. The entire screen or segments of the screen can be constructed in such a way that, for example, two or more circular or semi-circular, parallel tension rods with different bending radii are connected transversely by screen bars. The screen bars can be attached to the tension rods in various ways, e.g. welded to them. Preferably, the screen bars are drilled through and are penetrated by the tension rods.

This is particularly advantageous for screen bars with a rectangular cross-section. Further preferred spacers can be arranged between the screen bars, preferably on the tension rods, e.g. in the form of sleeves that surround the tension rods. In this way, a desired arrangement of the screen bars at a distance from each other and particularly preferably parallel to each other can be achieved.

According to a preferred embodiment, the screen bars can have different lengths. While in the case of the truncated cone-shaped screen, for example, some screen bars can be completely continuous, other screen bars can have a shorter length. This allows adjacent screen bars to be arranged parallel to each other. Such an arrangement can be selected for a one-piece screen as well as for a preferred multi-part design of the screen with a plurality of segments.

Even within the segments, the screen bars are preferably arranged parallel to each other and have different lengths.

A holding element can be provided as part of the screen structure, which extends along the screen surface-at an angle in the direction of flow. A segment of the screen can, for example, be laterally delimited by two holding elements, with tension rods preferably extending between the holding elements. The holding element preferably has stair-shaped steps. Screen bars can then be arranged in such a way that at least some of the screen bars end in the stair-shaped steps. In this way, screen gaps are formed between adjacent screen bars as screen slots, which at least at one end on the stair-shaped step have a transverse end, preferably at right angles to the screen bars, instead of a pointed convergence to which fibrous dirt in particular could ad-here more strongly.

According to a preferred embodiment, a screen basket is arranged on the cleaning element extractor, i.e. an area which is at least partially and preferably predominantly not equipped with a closed wall, but with a screen wall. The screen basket is preferably cylindrical in shape and has a screen wall in the radial direction. The screen basket is preferably arranged centrally within the pipe wall. Preferably, the screen basket forms the tip of the truncated cone formed by the screen surface. The screen basket preferably merges into an inlet area of the cleaning element extractor.

The device described above for separating cleaning elements can be part of a cleaning system for a heat exchanger. The cleaning system comprises a device for feeding cleaning elements arranged on a cooling water pipe upstream of the heat exchanger. The device described for separating the cleaning elements is arranged downstream of the heat exchanger in order to collect and remove the cleaning elements again after they have passed through the heat exchanger.

### BRIEF DESCRIPTION OF THE DRAWINGS

In the following, embodiments of the invention are described in more detail with reference to drawings. Thereby

FIG. 1 shows a longitudinal section through an embodiment of a device for separating cleaning elements with a screen and a cleaning element extractor in a pipe;

FIGS. 2, 3 show a top view and a perspective view of the screen and the cleaning element extractor shown in FIG. 1;

FIG. 4-6 show segments of the screen from FIGS. 2, 3 in perspective view, side view and front view;

FIG. 6a shows a schematic sectional view of a part of a segment from FIG. 4-6;

FIGS. 7a, 7b show a first and a second end of a vortex body according to a first embodiment of the device shown in FIG. 1;

FIGS. 8a, 8b show a partial schematic representation of a section through a sieve plane with a vortex body arranged above it according to FIGS. 7a, 7b;

FIGS. 9-11 show partially schematic representations of cross-sectional shapes of vortex bodies according to a second, third and fourth embodiment.

### DETAILED DESCRIPTION OF THE EMBODIMENTS

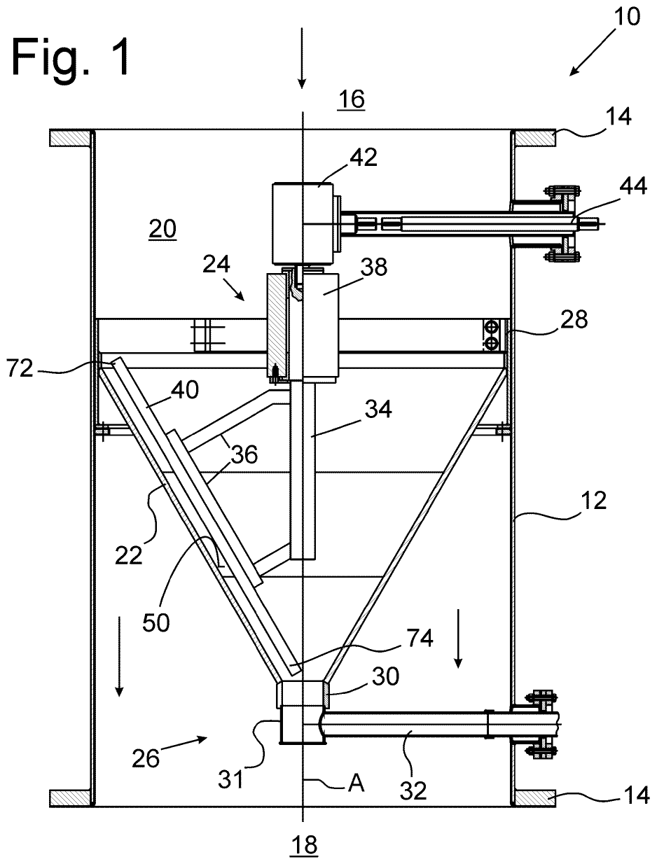

FIG. 1 shows an embodiment of a device 10 for separating cleaning elements from a fluid stream.

The device shown is part of a cleaning system for a heat exchanger (not shown), in which cleaning elements in the form of sponge rubber cleaning balls are fed into a cooling water flow upstream of the heat exchanger in a known manner, which pass through the pipes of the heat exchanger with the cooling water flow and clean them in the process. The device 10, which is also referred to below for simplicity as screen device 10, is arranged downstream of the heat exchanger and is used to separate and extract the cleaning elements from the cooling water flow.

For this purpose, the screen device 10 has a cylindrical pipe with a pipe wall 12 that defines a cylindrical interior space 20, as shown in longitudinal section in FIG. 1. Flanges 14 are used to connect to preceding and following sections of the pipe, for example within the system outlined above. The screen device 10 is arranged in such a way that the direction of flow of the water through the pipe is directed, as indicated by arrows in FIG. 1, from an upstream side 16 at the top in FIG. 1 to a downstream side 18 at the bottom.

In the interior space 20, the screen device 10 comprises a truncated cone-shaped screen 22, a lift-off device 24 and a cleaning element extractor 26.

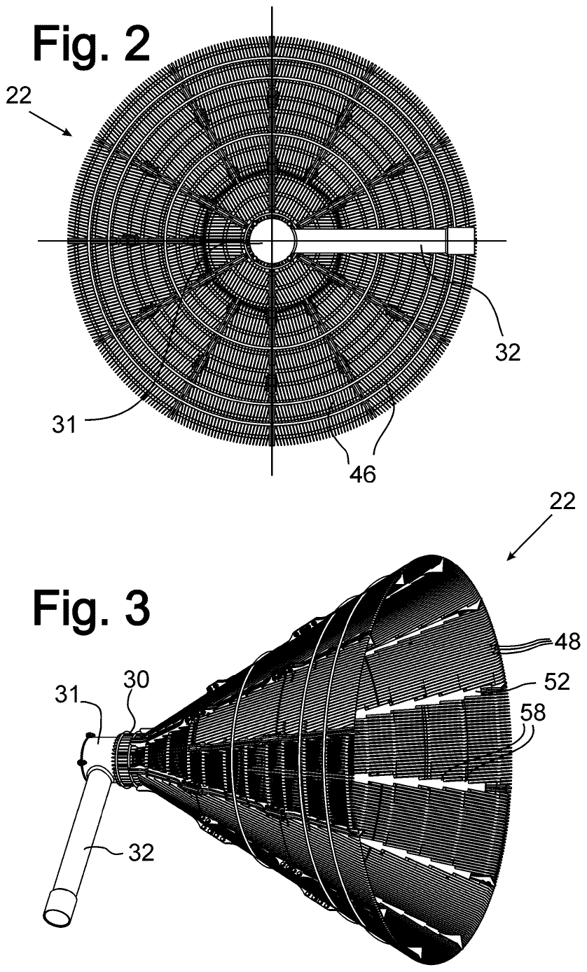

The screen 22 has a truncated cone-shaped screen surface 50 and is arranged centrally in the interior space 20, so that its longitudinal center axis coincides with a longitudinal center axis A of the pipe. The screen 22 is arranged in such a way that it tapers in the direction of flow. Starting from an outer attachment 28 on the wall 12, where the screen 22 covers the entire cross-section of the pipe, the screen surface of the screen 22 leads to a cylindrical screen basket 30, to which the cleaning element extractor 26 is connected with a collecting pot 31 and an extraction pipe 32 extending transversely to the axis A, which leads outwards through the pipe wall 12. As can be seen from FIG. 3, the walls of the collecting pot 31 are closed, while the wall of the cylindrical screen basket 30 is formed from preferably parallel screen bars.

The lift-off device 24 comprises a rotary shaft 34 to which an elongate vortex body 40 is attached by means of a holder 36 in such a way that it rotates with the rotary shaft 34 about the axis A. For this purpose, the rotary shaft 34 is mounted in a bearing 38 and coupled to a rotating drive (not shown) via an angular gear 42 and a drive shaft 44 passing through the pipe wall 12.

The vortex body 40 is arranged parallel to the screen surface 50 and at a distance therefrom such that it extends over the entire length of the screen 22. During the rotation of the unit comprising rotary shaft 34, holder 36 and vortex body 40, which is driven by drive shaft 40, the vortex body 40 thus sweeps over the entire screen surface 50.

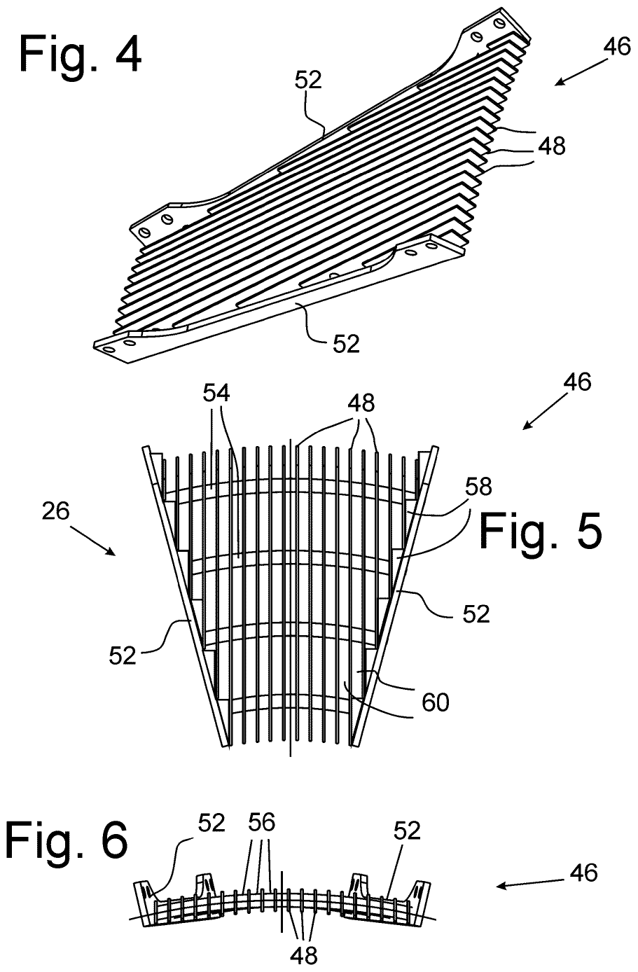

The screen 22 is shown separately in FIG. 2 in a view from below and in FIG. 3 in a perspective view. As can be seen there, the truncated cone shape is formed from a number of segments 46, one of which is shown separately in FIGS. 4-6. The segments 46 are joined together to form the screen 22 both laterally, i.e. in the circumferential direction of the truncated cone, and under each other, i.e. in the direction of the collecting pot 31.

As shown in FIG. 4-6, the segments 46 of the screen 22 are each composed of parallel screen bars 48, which are arranged between holding elements 52 and connected transversely by transversely extending, curved tension rods 54.

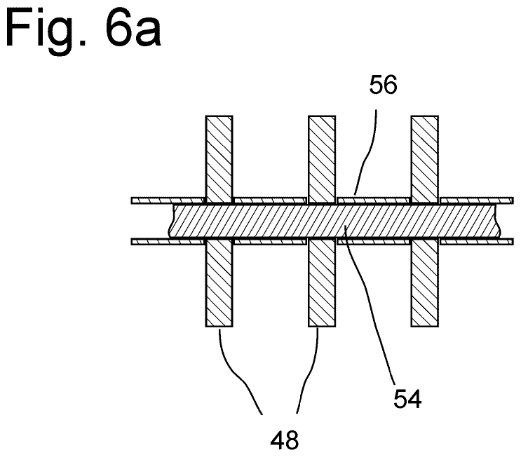

As can be seen in particular from FIG. 6a, the screen bars 48 have a rectangular cross-section, in the preferred embodiment with a height of 20 mm and a thickness of 2 mm.

As can be seen further from FIG. 6a, the screen bars 48 are drilled through and are penetrated by the tension rods 54. The screen bars 48 are held at a parallel distance from one an-other by spacer sleeves 56, which surround the tension rods 54.

As can be seen in particular from FIG. 5, the screen bars 48 of the segment 46 shown differ in terms of their length. While the central screen bars 48 extend over the full length of the segment 46, the outer screen bars 48 are shorter and end in stair-shaped steps 58 of the holding elements 52. Depending on the desired design, the stair-shaped steps 58 can be formed integrally with the holding elements 52, but preferably the steps 58 are formed by triangular covers which are attached separately, e.g. welded. The triangular covers can be arranged on the inside of the screen 22, for example, as shown in FIG. 5.

The stair-shaped steps 58 and parallel arrangement of the screen bars 48 ensure that the screen gaps have a rectangular cross-section. The screen bars 48 thus do not form any narrowing passages in which dirt would preferentially accumulate.

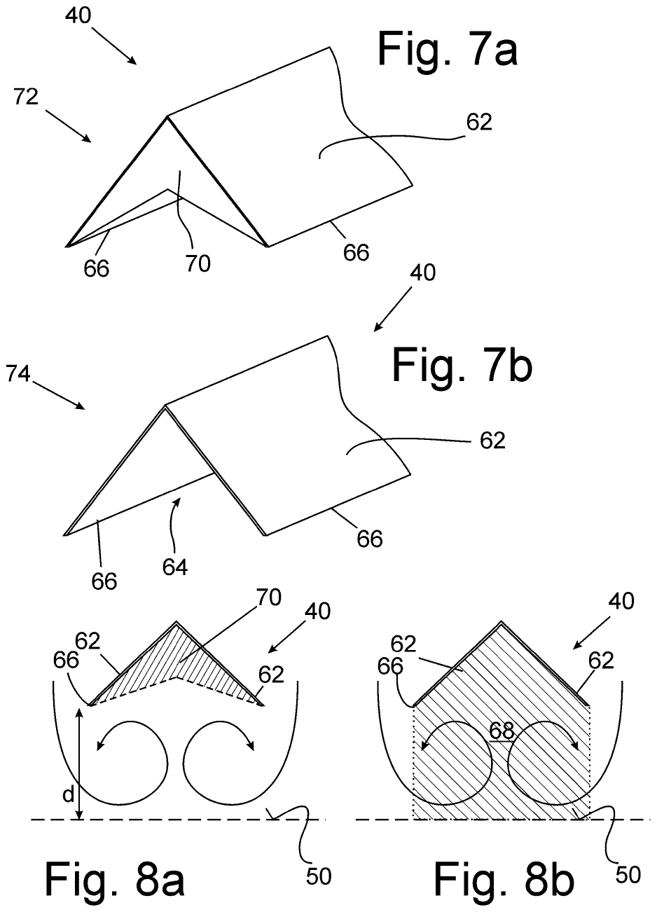

The vortex body 40 is designed as a narrow, elongated bar with a continuous profile shape. FIGS. 7a, 7b, 8a, 8b show the shape of the vortex body 40 according to a first embodiment.

The vortex body 40 has a profile shape that corresponds to a roof shape with two roof legs 62 of equal length in the example shown, which are arranged at an internal angle of approximately 90° to each other. In this way, an interior space 64 of the vortex body 40 is spanned, which is open downwards, i.e. in the direction of the screen surface 50.

The arrangement of the vortex body 40 relative to the screen surface 50 is shown in particular in FIGS. 8 a, 8 b. As shown there, a distance d remains between the lower edges 66 of the roof legs 62 and the screen surface 50. Thus, the intermediate space 68 shown hatched in FIG. 8b is formed, which is located below the roof legs 62 and is laterally limited by the perpendicular projection of the edges 66 onto the screen surface 50, and is thus composed of the downwardly open interior space 64 of the vortex body 40 and the rectangular area given by the distance d. As can be seen from FIGS. 8a, 8b, the interior space 64 is open laterally along the edges 66.

The cross-sectional shape of the vortex body 40 remains the same throughout, as shown in FIGS. 7b, 8b, with the exception of its end 72 pointing towards the upstream side 16 (see FIG. 1), which is referred to here as upper end 72 for the sake of simplicity.

FIG. 7a shows the upper end of the vortex body 40. As shown there, the interior space 64 of the vortex body 40 is partially closed at the upper end 72 by a cover 70. In the longitudinal direction of the vortex body 40, the cover 70 covers a part of the interior space 64 and/or likewise also a part of the entire intermediate space 68 to the screen surface 50.

No cover is provided at the lower end 74 of the vortex body 40 opposite the upper end 72; here the interior space 64 remains open in the longitudinal direction (FIG. 7b).

Due to the shape and arrangement of the vortex body 40 as shown and described above in a fluid stream, here in particular a water stream in the direction of flow from the upstream side 16 to the downstream side 18, defined, very advantageous flow conditions are formed. Due to the flow around the vortex body 40, in this case the roof leg 62, vortex flows are formed as indicated in FIGS. 8a, 8b. These vortex flows change the flow direction locally and partially reverse it, especially in the area of the screen surface 50. This allows dirt and deposits to be removed from there. In particular, cleaning elements that remain temporarily on the screen surface 50 are also loosened so that they can move along the screen surface 50 in the direction of the cleaning element extractor 26.

This movement is supported by a longitudinal component of the vortex flow, which results from the partial covering of the intermediate space 68. The cover 70 attached to the upper end 72 of the vortex body 40 thus causes flow conditions which support the transport of cleaning elements along the vortex body 40 to the cleaning element extractor 26.

With regard to the dimensioning of the cover 70, the inventors assume that-viewed in the longitudinal direction of the vortex body 40, as shown, for example, in FIG. 8a, 8b—the ratio of the covered area (see hatched area in FIG. 8a) to the area of the entire intermediate space 68 (see hatched area in FIG. 8b) is decisive. The effect of a longitudinal component of the resulting flow can therefore already be observed with a low degree of coverage of, for example, at least 5%. However, a considerably higher proportion of the area making up the intermediate space 68 can also be covered, for example up to 80%, i.e. the cover 70 can also cover the entire interior space 64 of the vortex body 40 and even protrude beyond the edges 66 in the direction of the screen surface 50. Good flow conditions can be achieved, for example, with a size of the cover 70 that corresponds to 10-40%, particularly preferably 10-30%, of the area forming the intermediate space 68.

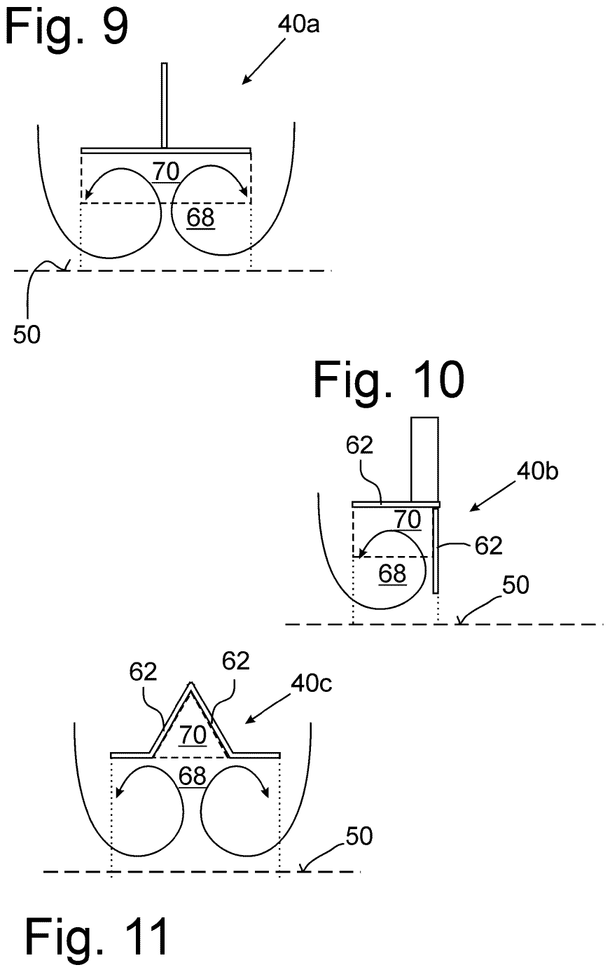

While the roof shape of the vortex body 40 shown in FIGS. 7a-8b has proven to be particularly suitable, very different designs are possible. FIGS. 9-11 show corresponding examples. In each case, the profile of the vortex body 40 is shown with solid lines, the shape and size of the front cover 70 with dashed lines and the intermediate space 68 with dotted lines.

In a second embodiment of a vortex body 40a according to FIG. 9, a T-profile is used, the flat side of which faces the screen surface 50. The intermediate space 68 is in each case limited by the perpendicular projection from the screen surface 50 to the edges of the flat side of the T-profile, which in this case do not protrude. The cover 70 is designed as a rectangular plate projecting in the direction of the screen surface 50.

In a third embodiment of a vortex body 40b according to FIG. 10, the vortex body 40b has a 90° angular shape which, however, in contrast to the first embodiment, is not aligned symmetrically to the perpendicular of the screen surface 50, but one leg 62 is parallel to the screen surface 50 and the second leg 62 is perpendicular to the screen surface 50. The cover 70 here is also rectangular in shape.

In the third embodiment according to FIG. 11, a vortex body 40c is formed as a roof shape with two legs 62, which in this case, however, are adjoined by extensions that extend parallel to the screen surface 50. A triangular sheet is provided as a cover 70, which in this case covers the entire interior space 64.

During operation of the screen device 10, a water flow with cleaning elements contained therein is supplied from the upstream side 16 when cleaning an upstream part of the system such as a heat exchanger. The cross-section of the pipe formed by the pipe wall 12 is completely covered by the screen 22 and the intermediate spaces 60 of the screen 22 are dimensioned in such a way that the cleaning elements cannot reach the downstream side 18, but are held back by the screen 22 and directed towards the cleaning element extractor 26. There they enter the catch pot 31 and are extracted via the extraction pipe 32 together with a certain amount of water.

This is supported by the operation of the lift-off device 24. For this purpose, the rotary shaft 34 is driven in rotation by means of the drive shaft 44 so that it rotates about the axis A and the vortex body 40 sweeps over the screen surface 50. The rotation can take place continuously in the same direction, but also in alternating swivel movements in opposite directions.

When the vortex body 40 passes over the screen surface 50, vortex flows are triggered locally in the water flow of the interior space 20 as described, which also have a longitudinal component in the direction of the cleaning element extractor 26. As a result, cleaning elements are lifted off the screen surface 50 and conveyed towards the screen basket 30 and the collecting pot 31 located behind it. In addition, the vortex flow loosens any dirt adhering to the screen 22.

The embodiments shown above are merely exemplary, in fact the invention can be implemented in various ways and numerous modifications to the embodiments shown are possible. For example, the shape of the screen 22 may vary so that the screen surface 50 is flatter or steeper than shown in the example of FIG. 1, in which the angle included between the axis A and the screen surface 50 is approximately 30°. Instead of just one vortex body 40, several vortex bodies can be attached to the axis of rotation of the rotary shaft 34, which together sweep over the screen surface 50.

### LIST OF REFERENCE SYMBOLS

A Longitudinal center axis
d Distance
10 Device for separating cleaning elements (screen device)
12 Pipe wall
14 Flanges
16 Upstream side
18 Downstream side
20 Interior
22 Screen
24 Lift-off device
26 Cleaning element extractor
28 Attachment
30 Screen basket
31 Collecting pot
32 Extraction pipe
34 Rotary shaft
36 Holder
38 Bearing
40 Vortex body
42 Angular gear
44 Drive shaft
46 Segments
48 Screen bars
50 Screen surface
52 Holding elements
54 Tension rods
56 Spacer sleeves
58 stair-shaped steps
60 Screen gaps
62 Roof leg
64 Interior of the vortex body
66 Edges of the roof legs
68 Intermediate space
70 Cover
72 Upper end of the vortex body
74 Lower end of the vortex body

1. Device for separating cleaning elements from a fluid stream, with
a pipe wall for directing the fluid stream from an upstream side to a downstream side,
a screen arranged inside the pipe wall with a frustoconical screen surface for guiding cleaning elements to a cleaning element extractor arranged in the direction of the downstream side,
a lift-off device with at least one vortex body arranged at least substantially parallel to the screen surface at a distance from the screen surface the vortex body being arranged to rotate or swivel about a rotary shaft in such a way that it sweeps over the screen surface,
wherein an intermediate space is formed between the vortex body and the screen surface,
wherein the vortex body has a cover at least at the end directed towards the upstream side by which the intermediate space is partially closed such that the cover covers at least 5% and not more than 80% of a cross-sectional area of the intermediate space.

2. Device according to claim 1, in which
the intermediate space is open at the side.

3. Device according to claim 1, in which
the vortex body has a roof shape in cross-section with two roof legs arranged at an angle of 60-120°.

4. Device according claim 1, wherein
the vortex body has a pitch circle shape, angled shape, U-shape, T-shape or polygon shape in cross-section.

5. Device according to claim 1, in which
the vortex body has a distance from the screen surface of 20-80 mm.

6. Device according to claim 1, in which
the screen comprises a plurality of parallel screen bars with the screen bars extending obliquely in the direction of flow.

7. Device according to claim 1, in which
the screen has a plurality of screen bars with a rectangular cross-section.

8. Device according to claim 1, in which
the screen has one or more tension rods which are curved in a circular or pitch circle shape,
wherein screen bars are connected to the tension rods.

9. Device according to claim 8, in which
spacers are arranged between the screen bars.

10. Device according to claim 6, wherein
a part of the screen bars ends in stair-shaped steps of at least one holding element extending obliquely in the direction of flow.

11. Device according to claim 10, wherein
the stair-shaped steps are formed by means of covers.

12. Device according to claim 1, wherein
the cleaning element extractor has a cylindrical screen basket adjoining the screen.

13. Cleaning system for a heat exchanger, with
a device for feeding cleaning elements arranged on a cooling water pipe upstream of a heat exchanger,
and a device arranged downstream of the heat exchanger for separating the cleaning elements according to claim 1.

14. Process for separating cleaning elements from a fluid stream, in which
a fluid stream is directed within a pipe wall from an upstream side to a downstream side,
and the fluid stream is screened by means of a screen with a frustoconical screen surface arranged inside the pipe wall so that the cleaning elements are directed towards the cleaning element extractor arranged on the downstream side,
wherein a lift-off device with at least one vortex body arranged at least substantially parallel to the screen surface rotates about a rotary shaft in such a way that the vortex body sweeps over the screen surface,
wherein an intermediate space is formed between the vortex body and the screen surface,
and wherein the vortex body has a cover at least at one end directed towards the upstream side by means of which the intermediate space is at least partially closed.
